(19) United States
(12) Patent Application Publication
(10) Pub. No.: US 2019/0058875 A1
(43) Pub. Date: Feb. 21, 2019

(54) Three-Dimensional Surveillance System, and Rapid Deployment Method for Same

(71) Applicant: Hangzhou Hikvision Digital Technology Co., Ltd., Hangzhou, Zhejiang (CN)

(72) Inventors: Quanzhan WANG, Hangzhou, Zhejiang (CN); Liang LI, Hangzhou, Zhejiang (CN); Yaodong LIN, Hangzhou, Zhejiang (CN)

(73) Assignee: Hangzhou Hikvision Digital Technology Co., Ltd., Hangzhou, Zhejiang (CN)

(21) Appl. No.: 16/070,426

(22) PCT Filed: May 6, 2016
(86) PCT No.: PCT/CN2016/081260

§ 371 Date: Jul. 16, 2018

(30) Foreign Application Priority Data
Jan. 21, 2016 (CN) 201610040812.8

(51) Int. Cl. H04N 13/388

(52) U.S. Cl. CPC H04N 13/388

(57) ABSTRACT

The present application relates to a video surveillance technology, and discloses a 3D monitoring system and a rapid deployment method for the same. In the present application, two corresponding point sets are obtained by means of an input device respectively in a virtual scene and in a monitoring video, so as to obtain a mapping between the virtual scene and the monitoring video; and a video mesh, to be superimposed and displayed on the virtual scene, is generated based on this mapping. Thus, a 3D monitoring system can be rapidly deployed without calibrations of intrinsic and extrinsic parameters of a camera, and requirements on accuracy in matching between a 3D monitoring scene and an actual monitored site are decreased, greatly reducing the difficulty in system deployment while ensuring the effect of superimposing a monitoring video on a virtual scene.

The present application claims the priority to a Chinese Patent Application No. 201610040812.8, filed with the State Intellectual Property Office of the People's Republic of China on Jan. 21, 2016 and entitled “THREE-DIMENSIONAL SURVEILLANCE SYSTEM, AND RAPID DEPLOYMENT METHOD FOR SAME”, which is incorporated herein by reference in its entirety.

### TECHNICAL FIELD

The present application relates to video monitoring technologies, and particularly to a 3D monitoring system and a rapid deployment method for the same.

### BACKGROUND

A 3D monitoring system overcomes limitations of a traditional video monitoring system that pictures from different lenses are displayed for one scene. It integrates isolated cameras into a 3D real scene, and achieves 3D real-time monitoring of the whole scene. The 3D monitoring system not only can perform a real-time 3D fusion on real-time videos captured by cameras, but also can backtrack the stored 3D historical videos captured by the cameras. It can intuitively and panoramically present the occurrence of historical events, greatly improving the efficiency of event querying.

The existing 3D monitoring system generally establishes a 3D virtual scene for a monitored site, adds virtual camera devices in the virtual scene based on the actual positions of camera devices in the monitored site, determines the projection relation of a video to the virtual scene based on video parameter information, and establishes a virtual scene roaming system. During research and development, the inventors found the shortcoming of the prior art, that is, the 3D monitoring system needs to obtain intrinsic and extrinsic parameters of camera devices by for example calibration, and there is a one-to-one correspondence between a camera device and its projection in the virtual scene, making the deployment inconvenient and inflexible.

### SUMMARY

An objective of the present application is to provide a 3D monitoring system and a rapid deployment method for the same, which can greatly reduce the difficulty in system deployment when deploying the 3D monitoring system.

In order to solve the above technical problem, embodiments of the present application disclose a rapid deployment method for a 3D monitoring system, which includes:

displaying a virtual scene and a monitoring video of a monitored site;

obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring video is formed;

generating a first video mesh according to the first mapping, wherein a texture of the first video mesh is at least a part of the monitoring video; and

superimposing and displaying the first video mesh on the virtual scene.

Embodiments of the present application further disclose a 3D monitoring system, including:

a display module, configured to display a virtual scene and a monitoring video of a monitored site;

an obtaining module, configured to obtain, through an input device, N points selected in the virtual scene as a first point set, and obtain, through an input device, N points selected in the monitoring video as a second point set, wherein N is greater than 2, and there is a one-to-one correspondence between points in the first point set and points in the second point set respectively, so that a first mapping between the virtual scene and the monitoring video is formed;

a generation module, configured to generate a first video mesh according to the first mapping, wherein a texture of the first video mesh is at least a part of the monitoring video; and

a superimposing module, configured to superimpose and display the first video mesh on the virtual scene.

The present application further provides a 3D monitoring system, including a housing, a processor, a memory, a circuit board and a power supply circuit, wherein the circuit board is arranged inside a space enclosed by the housing, the processor and the memory are provided on the circuit board; the power supply circuit is configured to supply power for various circuits or elements of the 3D monitoring system; the memory is configured to store executable program code, and the processor executes a program corresponding to the executable program code by reading the executable program code stored in the memory to perform the rapid deployment method for a 3D monitoring system.

The present application further provides an application program performing the rapid deployment method for a 3D monitoring system when executed.

The present application further provides a storage medium, configured to store an application program, which, when executed, performs the rapid deployment method for a 3D monitoring system.

Compared to the prior art, the main difference and effect of the embodiments of the present application are: two corresponding point sets are obtained through an input device respectively in a virtual scene and in a monitoring video, so as to obtain a mapping between the virtual scene and the monitoring video; and a video mesh, to be superimposed and displayed on the virtual scene, is generated based on this mapping. Thus, a 3D monitoring system can be rapidly deployed without calibrations of intrinsic and extrinsic parameters of cameras, and requirements on accuracy in matching between a 3D monitoring scene and an actual monitored site are decreased, greatly reducing the difficulty in system deployment while ensuring the effect of superimposing a monitoring video on a virtual scene.

Further, the first and second point sets contain at least four feature points at the boundaries of regions respectively, and the boundaries of pictures in a video superimposed on a virtual scene is determined based on these feature points. Thus, the boundaries of pictures in monitoring videos can match the virtual scene very well even in a complex scene without serious distortion.

Further, 3D feature points in the first point set can be projected to a 2D space constituted by the second point set, by triangulating the first and second point sets and then performing video superimposition, to perform monitoring video superimposition more accurately.

Further, it can reduce the distortion in a mapped monitoring video, by determining whether the difference between the angle between any two edges of a triangle mesh of the first point set and the angle between corresponding two edges of a corresponding triangle mesh of the second point set is less than a preset threshold.

Further, a plurality of video meshes are generated for a same monitoring video in the virtual scene, which can lead to accurate access right control over the regions in the monitoring video and effectively alleviate the issues for high edge distortions caused by overabundance of feature points.

### BRIEF DESCRIPTION OF DRAWINGS

FIG. 1 is a schematic flowchart of a rapid deployment method for a 3D monitoring system according to a first embodiment of the present application;

FIG. 2 is a schematic flowchart of a rapid deployment method for a 3D monitoring system according to the first embodiment of the present application;

FIG. 3 is a schematic diagram illustrating triangulation of a point set in the rapid deployment method for a 3D monitoring system according to a second embodiment of the present application;

FIG. 4 is a schematic flowchart of a rapid deployment method for a 3D monitoring system according to the second embodiment of the present application;

FIG. 5 is a schematic flowchart of selecting feature points and generating a mesh model in the rapid deployment method for a 3D monitoring system according to the second embodiment of the present application;

FIG. 6 is a schematic structural diagram of a 3D monitoring system according to the second embodiment of the present application;

FIG. 7 is a schematic structural diagram of a 3D monitoring system according to a third embodiment of the present application;

FIG. 8 is a schematic structural diagram of a generation module in a 3D monitoring system according to a fourth embodiment of the present application.

### DETAILED DESCRIPTION

In the following description, many technical details are set forth to help readers to better understand the present application. However, a person having ordinary skills in the art can understand the technical solutions claimed in the claims of the present application can be realized even without these technical details as well as variations and modifications based on the following embodiments.

In order to make the objectives, the technical solutions, and the advantages of the present application more clear, the embodiments of the present application will be described in further details in conjunction with the accompanying drawings.

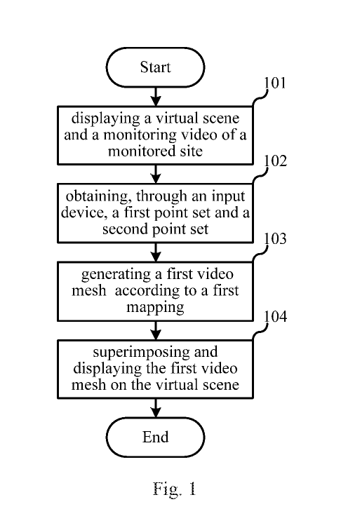

The first embodiment of the present application relates to a rapid deployment method for a 3D monitoring system. FIG. 1 is a schematic flowchart of this rapid deployment method for a 3D monitoring system. As shown in FIG. 1, the rapid deployment method for a 3D monitoring system includes:

Step 101, displaying a virtual scene and a monitoring video of a monitored site. The virtual scene should be established in advance for the monitored site. One or more camera devices are arranged at different locations in the monitored site. It is possible to display monitoring videos from all the camera devices arranged in the monitored site in a plurality of windows at the same time, or only display a monitoring video of one camera device in one window.

Step 102, obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring video is formed.

The input device can be a mouse, a touch pad, a touch screen, a stylus, and the like. A same input device or different input devices can be used to select points in the virtual scene and in the monitoring video. For example, a mouse is used to select points in the virtual scene, and a touch screen is used to select points in the monitoring video.

As an optional embodiment, the first point set is used to select a first region in the virtual scene, and the second point set is used to select a second region in the monitoring video. The first point set contains at least four feature points located at the boundary of the selected first region, and the second point set contains at least four feature points located at the boundary of the selected second region, such as the four corner points of a gate. The first and second point sets each contains at least four feature points at the boundaries of regions, and the boundary of a picture in a video superimposed on the virtual scene can be determined based on these feature points. Thus, the boundary of the picture in the monitoring video can match with the virtual scene very well without serious distortion even in a complex scene. In addition, in another example, the first point set can contain three or more than four feature points located at the boundary of a selected image, and this is also true for the second point set.

Preferably, the first point set contains at least one feature point located within the selected first region, and the second point set contains at least one feature point located within the selected second region, such as a door handle. In addition, in another example, the first point set may contain no feature point located within the selected first region or may contain a plurality of feature points located within the selected first region, and a similar situation applies to the second point set.

Step 103, generating a first video mesh according to the first mapping, wherein a texture of the first video mesh is at least a part of the monitoring video. The video mesh is a mesh model used to carry pictures of a monitoring video, and video data is used as the texture of this mesh and is updated in real time so that the video is fused in the virtual scene.

Step 104, superimposing and displaying the first video mesh on the virtual scene.

Two corresponding point sets are obtained through an input device respectively in a virtual scene and in a monitoring video, so as to obtain a mapping between the virtual scene and the monitoring video; and a video mesh, to be superimposed and displayed on the virtual scene, is generated based on this mapping. Thus, a 3D monitoring system can be rapidly deployed without calibrations of intrinsic and extrinsic parameters of cameras, and the requirement on accuracy in matching between a 3D monitoring scene and an actual monitored site is decreased, which greatly reduces the difficulty in system deployment while ensuring the effect of superimposing a monitoring video on a virtual scene.

In a preferred embodiment, as shown in FIG. 2, after the step 101, the method further includes:

Step 202, obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed.

Step 203, generating a second video mesh according to the second mapping, wherein a texture of the second video mesh is at least a part of the same monitoring video.

Step 204, superimposing and displaying the second video mesh on the virtual scene.

In the virtual scene, a plurality of video meshes are generated for a same monitoring video, which can perform accurate access right control over regions in this monitoring video, simplify the arrangement of camera devices, and effectively alleviate the issues for high edge distortions caused by overabundance of feature points.

In the above preferred examples, the texture of the first video mesh and the texture of the second video mesh are a first part and a second part in the same monitoring video. In various embodiments of the present application, there may be or may not be an overlap between the first part and the second part, in order to carry out accurate access right control according to actual requirements. For example, the first part and the second part are two regions in the same monitoring video and there is no overlap between the two regions, and the two regions can thus be monitored separately; alternatively, the first part is the whole region in the monitoring video, and the second part is only a certain region in this monitoring video, such as a window or a door, and the regions can thus be monitored according to related access rights.

It can be understood, steps 102 to 104 and steps 202 to 204 can be performed simultaneously or successively.

In addition, in other embodiments of the present application, it is also possible to generate only one video mesh for one monitoring video in a virtual scene, and in this case, the technical solutions of the present application can also be accomplished.

The second embodiment of the present application relates to a rapid deployment method for a 3D monitoring system. In the second embodiment, the following two improvements have been made on the basis of the first embodiment.

The first improvement is that 3D feature points in the first point set can be projected to a 2D space constituted by the second point set, by triangulating the first and second point sets and then performing video superimposition, so as to perform monitoring video superimposition more accurately. Specifically, step 103 includes:

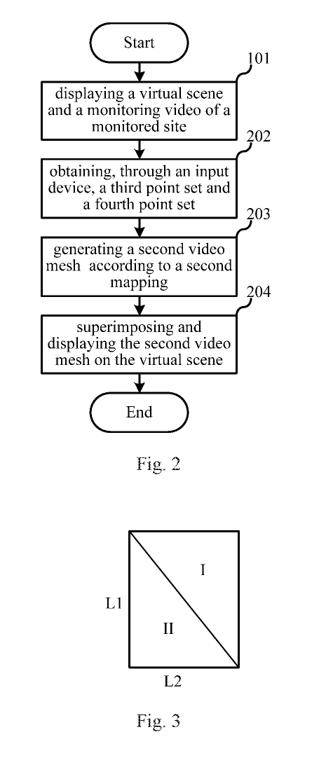

triangulating the first and second point sets respectively to generate triangle meshes, e.g., as shown in FIG. 3, two triangles I and II are formed by four points, and there is a certain angle between the edges of the triangles I and II;

superimposing a monitoring video corresponding to a triangle mesh of the second point set, as a texture, onto a corresponding triangle mesh of the first point set according to the first mapping to generate the first video mesh.

Three points can form a face, and triangulation is to connect various points to form triangle meshes. After triangulation of the first point set, one or more faces can be formed by various 3D feature points in the first point set. The monitoring video in each of the faces formed by the second point set is superimposed onto a corresponding face formed by the 3D feature points in the first point set according to the first mapping, and appropriate adjustment can be performed if needed, such that the monitoring video superimposition can be carried out more accurately.

In addition, in other embodiments of the present application, it is also possible not to triangulate the point sets, or, other mesh processing can be performed on the point sets according to actual requirements, e.g., processing of a quadrangle mesh or a mesh of other shapes.

The second improvement is determining whether the difference between the angle between any two edges of the triangle mesh of the first point set and the angle between corresponding two edges of the corresponding triangle mesh of the second point set is less than a preset threshold, which can lead to a less distortion in pictures of a monitoring video after being mapped.

Specifically, after the step of triangulating the first and second point sets respectively to generate triangle meshes, and before the step of superimposing a monitoring video corresponding to a triangle mesh of the second point set, as a texture, onto a corresponding triangle mesh of the first point set according to the first mapping to generate the first video mesh, the method further includes:

determining whether the difference between the angle between any two edges of the triangle mesh of the first point set and the angle between corresponding two edges of the corresponding triangle mesh of the second point set (such as, the angle between the edges L1 and L2 as shown in FIG. 3) is less than a preset threshold;

if the difference is less than the preset threshold, superimposing a monitoring video corresponding to the triangle mesh of the second point set, as a texture, onto the corresponding triangle mesh of the first point set according to the first mapping to generate the first video mesh; otherwise, returning to step 102 to obtain the point sets again.

That is, if it is determined that the difference between the angle between any two edges of a triangle mesh of the first point set and the angle between corresponding two edges of a corresponding triangle mesh of the second point set is less than the preset threshold, the following step will be performed: superimposing a monitoring video corresponding to the triangle mesh of the second point set, as a texture, onto the corresponding triangle mesh of the first point set according to the first mapping to generate the first video mesh. This preset threshold can be set according to actual situations and can be adjusted when necessary.

For a mesh of another shape, it can determine the difference between the angle between any two edges of each mesh, and the present application is not limited to the triangle mesh mentioned above.

In addition, in other embodiments of the present application, it is possible not to determine the difference of angles of two edges. Instead, it can determine the similarity of the geometric structure of each face formed by 3D feature points in the first point set with that in the second point set.

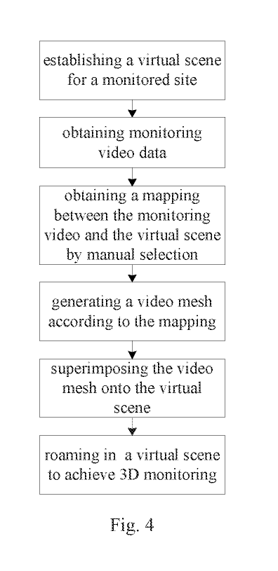

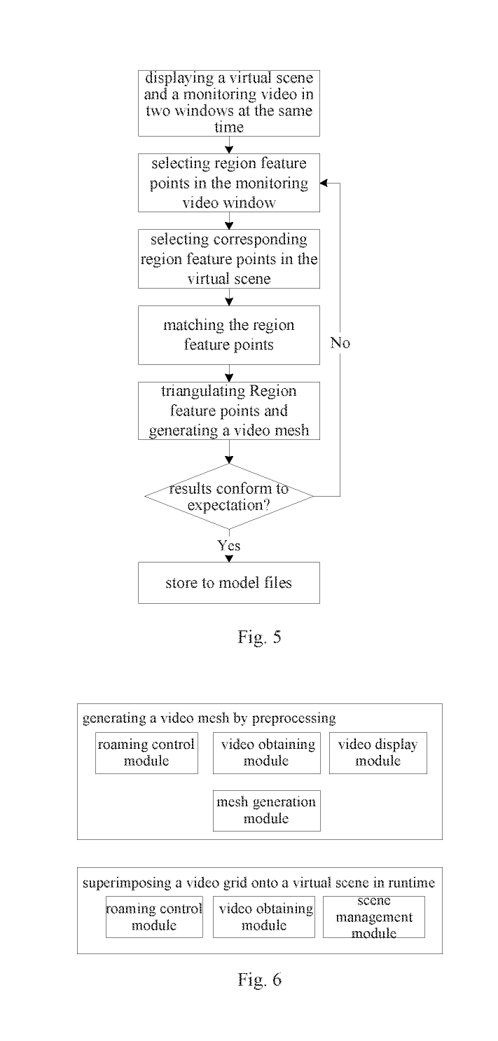

In a preferred example, the rapid deployment method for a 3D monitoring system, as shown in the overall flowchart of FIG. 4, includes: establishing a 3D virtual scene for a monitored site, obtaining video data from a video acquisition device (such as a camera device), obtaining a mapping between the monitoring video and the virtual scene by manual selection, generating a video mesh according to the mapping, superimposing the video mesh onto the original virtual scene, and building a virtual scene roaming system to accomplish the 3D monitoring. Virtual roaming is an important branch of virtual reality (VR) technology. It creates a virtual information environment in multi-dimensional information space, provides an immersive experience for users, has an enhanced ability to interact with the environment, and facilitates inspire conception. As shown in FIG. 5, obtaining a mapping between the monitoring video and the virtual scene by manual selection specifically includes: displaying the virtual scene and the monitoring video in two windows at the same time; adjusting the monitoring pose of the virtual scene to roughly match with the monitoring video region; selecting points at the boundary of a region in the monitoring video from a picture of the monitoring video by clicking with a mouse or by other ways (e.g., touching on a touch screen); selecting region feature points from a region in the virtual scene which corresponds to the region in the monitoring video, wherein the region feature points form 3D point cloud data; and generating a mesh model through mesh processing (wherein, the mesh is formed by connecting several 3D points and can have a variety of shapes, such as a triangle or a quadrangle). The relative coordinates of region feature points in the picture of the monitoring video are used as the texture coordinates of the corresponding region feature points in the virtual scene to determine a mapping. A video mesh is generated according to the mapping and the video mesh is superimposed and displayed on the virtual scene to achieve the 3D monitoring. In this process, region feature points can be selected for many times for the same monitoring video, and region feature points of the corresponding virtual scene are selected at the same time to generate a plurality of mesh models, which can lead to accurate access right control over the regions in the same monitoring video and effectively alleviate issues for high edge distortions caused by overabundance of feature points. Selection by clicking with a mouse refers to obtaining 2D/3D spatial coordinates of a corresponding point by clicking the mouse.

The process of matching the region feature points in FIG. 5 includes: projecting 3D feature points selected in a virtual scene of a monitored site to a 2D space; determining whether the geometric structure of each face formed by region feature points selected in the virtual scene is similar to that formed by region feature points in a picture of the monitoring video; and determining whether the difference between the angle between any two edges of the geometric structure of each face formed by region feature points selected in the virtual scene and the angle between corresponding edges in the monitoring video is smaller than a control threshold, if not, prompting to select again; which ensures a less distortion in the picture of the monitoring video after being mapped.

That is, the control threshold is the preset threshold, and can be adjusted according to the actual situation. If technology supports, the smaller the control threshold, the lower the distortion in a mapped picture of a monitoring video.

The rapid deployment method for a 3D monitoring system can be implemented on the following 3D monitoring system, which includes, for example, a roaming control module, a video display module, a video obtaining module, a scene management module, and a mesh generation module.

The roaming control module is configured for controlling viewpoint roaming, including, among others, cruise along a fixed line, cruise in a flight mode, and first person roaming.

The video obtaining module is configured for obtaining files or real-time streams, and for video decoding, data cache control, and the like.

The video display module is configured for displaying video data on a two-dimensional window for manual selection of feature points in a monitoring region, and for switching from 3D monitoring to 2D monitoring.

The scene management module is configured to manage the loading/unloading of a video mesh and add it to the 3D monitoring system by predicting the viewpoint at the next stage. In addition, the scene management module includes a superimposing module for superimposing and displaying the video mesh on a virtual scene.

The mesh generation module is configured to triangulate a 3D point cloud based on manually selected region feature points, and generate a video mesh and store it as model files on a storage medium for persistence.

The coordination relation between the above modules is shown in FIG. 6. Basically, there are two stages for the 3D monitoring system: a deployment stage and a stage of implementing the monitoring. The deployment stage is the stage of preprocessing to generate a video mesh, including: obtaining video images and the intuitive presentation of the video images by the video obtaining module and the video display module; obtaining a picture of a 3D scene by the roaming control module; obtaining feature points in a mapped video region and those in a 3D monitoring region by manually clicking with a mouse; generating the video mesh by the mesh generation module based on these feature points; and storing the generated video mesh on a storage medium for persistence. This process can be repeated to improve the effect of the fusion of the video and the virtual scene. In this process, a plurality of video meshes can be generated for the same monitoring video, which reduces the distortion in edges and accurately controls access rights. The stage of implementing the monitoring is superimposing the video mesh onto the virtual scene in runtime, including: the roaming control module controls the change of virtual viewpoints to obtain a real-time 3D picture; the scene management module predicts the operating trend of the viewpoints, calculates the visible range, performs loading/unloading operations on the video mesh, and controls the monitoring video to be displayed on the corresponding monitoring screen; the video obtaining module obtains video data in real time, and updates the corresponding video mesh with the video data, and accomplishes the superimposing of the video on the virtual scene, thus achieving the 3D monitoring.

As can be seen from above, with the rapid deployment method for a 3D monitoring system, the 3D monitoring system can be rapidly deployed without calibrations of intrinsic and extrinsic parameters of cameras, the requirement on accuracy in matching between a 3D monitoring scene and an actual monitored site is decreased greatly, reducing the difficulty in system deployment while ensuring the effect of superimposing a video on a virtual scene, and a part of content in one monitoring video can be shielded to accurately control access rights.

The above improvements are combined to form a preferable embodiment of the present application, but the improvements can also be applied separately. In this preferable embodiment, certain step(s) and/or module(s) can be added, adjusted or deleted as needed.

All embodiments of the method of the present application can be implemented as software, hardware, firmware, and the like. Instruction code can be stored in any type of computer accessible memories (such as, permanent or modifiable, volatile or non-volatile, solid or non-solid, fixed or replaceable media, etc.) no matter in which way (as software, hardware, or firmware) the above methods are implemented. Similarly, the memory can be such as a programmable array logic (PAL), a random access memory (RAM), a programmable read-only memory (PROM), a read-only memory (ROM), an electrically erasable programmable ROM (EEPROM), a disk, an optical disc, or a digital versatile disc (DVD).

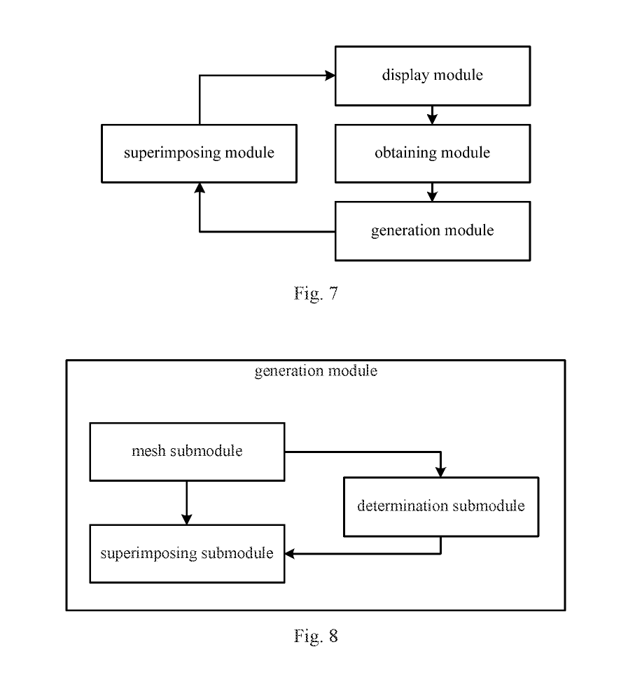

The third embodiment of the present application relates to a 3D monitoring system. FIG. 7 is a schematic structural diagram of the 3D monitoring system. As shown in FIG. 7, the 3D monitoring system includes:

a display module, configured to display a virtual scene and a monitoring video of a monitored site;

an obtaining module, configured to obtain, through an input device, N points selected in the virtual scene as a first point set, and obtain, through an input device, N points selected in the monitoring video as a second point set, wherein N is greater than 2, and there is a one-to-one correspondence between points in the first point set and points in the second point set respectively, so that a first mapping between the virtual scene and the monitoring video is formed.

The input device can be a mouse, a touch pad, a touch screen, a stylus, and the like. One input device or different input devices can be used to select points in the virtual scene and the monitoring video. For example, a mouse is used to select points in the virtual scene, and a touch screen is used to select points in the monitoring video.

As an optional embodiment, the first point set is used to select a first region in the virtual scene, and the second point set is used to select a second region in the monitoring video. The first point set contains at least four feature points located at the boundary of the selected first region, and second point set contains at least four feature points located at the boundary of the selected second region, such as the four corner points of a gate. The first and second point sets contain at least four feature points at the boundaries of regions respectively, and the boundary of a picture of a video superimposed on the virtual scene is determined based on these feature points. Thus, the boundary of the picture of the monitoring video can match with the virtual scene very well without serious distortion even in a complex scene. In addition, in another example, the first point set can contain three or more than four feature points located at the boundary of a selected image, and this situation is also true for the second point set.

Preferably, the first point set contains at least one feature point located within the selected first region, and the second point set contains at least one feature point located within the selected second region. In addition, in another example, the first point set may contain no feature point or may contain a plurality of feature points located within the selected regions, and a similar situation applies to the second point set.

A generation module, configured to generate a first video mesh according to the first mapping, wherein a texture of the first video mesh is at least a part of the monitoring video; and

a superimposing module, configured to superimpose and display the first video mesh on the virtual scene.

The obtaining module obtains two corresponding point sets through an input device respectively in a virtual scene and in a monitoring video, so as to obtain a mapping between the virtual scene and the monitoring video; and then the generation module generates, based on this mapping, a video mesh to be superimposed and displayed on the virtual scene. Thus, rapid deployment of a 3D monitoring system is achieved without calibrations of intrinsic and extrinsic parameters of cameras, and the requirement on accuracy in matching between a 3D monitoring scene and an actual monitored site is decreased, which greatly reduces the difficulty in system deployment while ensuring the effect of superimposing a monitoring video onto a virtual scene.

In an preferable example, the obtaining module is configured to obtain, through an input device, N points selected in the virtual scene as a third point set, and obtain, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed.

The generation module is configured to generate a second video mesh according to the second mapping, wherein a texture of the second video mesh is at least a part of the same monitoring video.

The superimposing module is configured to superimpose and display the second video mesh on the virtual scene.

A plurality of video meshes are generated for the same monitoring video in a virtual scene, which can perform accurate access right control over the regions in this monitoring video, simplify the arrangements of cameras, and effectively alleviates the issues for high edge distortions caused by overabundance of feature points.

In the above preferred examples, the texture of the first video mesh and that of the second video mesh can be a first part and a second part of the same monitoring video, respectively. In various embodiments of the present application, there may be or may be not an overlap between the first part and the second part, to carry out accurate access right control as needed. For example, the first part and the second part are two regions in a same monitoring video without being overlapped with each other, and the two regions can thus be monitored separately; or, the first part is the whole region in the monitoring video, and the second part is only a certain region in this monitoring video, such as a window, a door, and the regions can thus be monitored according to corresponding access rights.

In addition, in other embodiments of the present application, it is also possible to generate only one video mesh for one monitoring video in a virtual scene.

The first embodiment is an embodiment of a method corresponding to this embodiment, which can be implemented in conjunction with the first embodiment. The relevant technical details mentioned in the first embodiment can also be applied to this embodiment, which are not described again for clarify. Accordingly, the relevant technical details mentioned in this embodiment can also be applied to the first embodiment.

The fourth embodiment of the present application relates to a rapid deployment system for a 3D monitoring system. In the fourth embodiment, two improvements have been made on the basis of the third embodiment.

The first improvement is that 3D feature points in the first point set can be projected to a 2D space constituted by the second point set, by triangulating the first and second point sets and then performing video superimposition, so as to perform monitoring video superimposition more accurately.

Specifically, as shown in FIG. 8, the generation module includes the following submodules:

a mesh submodule, configured to triangulate the first and second point sets respectively to generate triangle meshes,

a superimposing submodule, configured to superimpose a monitoring video corresponding to a triangle mesh of the second point set, as a texture, onto a corresponding triangle mesh of the first point set according to the first mapping to generate the first video mesh.

Three points can form a face, after triangulation of the first point set, one or more faces can be formed by various 3D feature points in the first point set. The monitoring video in each of the faces formed by the second point set is superimposed onto the corresponding face formed by 3D feature points in the first point set according to the first mapping, appropriate adjustment can be performed as needed, so that monitoring video superimposition can be carried out more accurately.

In addition, in other embodiments of the present application, it is also possible not to triangulate the point sets, or, other mesh processing can be performed on the point sets as needed, e.g., quadrangle mesh processing or processing of a mesh of other shapes.

The second improvement is determining whether the difference between the angle between any two edges of the triangle mesh of the first point set and the angle between corresponding two edges of the corresponding triangle mesh of the second point set is less than a preset threshold, which can lead to less distortions in pictures of a monitoring video after being mapped.

Specifically, as shown in FIG. 8, the generation module further includes a determination submodule configured to determine whether the difference between the angle between any two edges of the triangle mesh of the first point set generated by the mesh submodule and the angle between corresponding two edges of the corresponding triangle mesh of the second point set is less than a preset threshold.

The superimposing submodule is configured to, in response to a determination from the determination submodule that the difference is less than the preset threshold, superimpose a monitoring video corresponding to the triangle mesh of the second point set, as a texture, onto the corresponding triangle mesh of the first point set according to the first mapping to generate the first video mesh.

For a mesh of another shape, it can determine the difference of the angle between any two edges of each mesh, and the present application is not limited to the triangle mesh mentioned above.

In addition, in other embodiments of the present application, it is also possible not to determine the difference between angles of two edges. Instead, it can determine the similarity of the geometric structure of each face formed by 3D feature points in the first point set with that in the second point set.

The second embodiment is an embodiment of a method corresponding to this embodiment, which can be implemented in conjunction with the second embodiment. The relevant technical details mentioned in the second embodiment can applied to this embodiment, and will not be described again to reduce duplication. Accordingly, the relevant technical details mentioned in this embodiment can also be applied to the second embodiment.

In summary, the 3D monitoring system and the rapid deployment method for the same in the present application mainly have the following advantages:

1. The correspondence between a monitoring video and a virtual scene is obtained by manual selection of regions, and thus no calibration of intrinsic and extrinsic parameters of cameras is required, which decreases requirements on accuracy in matching between a 3D monitoring scene and an actual monitored site.

2. It is possible that one monitoring camera corresponds to a plurality of mesh regions in the virtual scene, which can shield a part of content within one monitoring video while reducing the distortion of the boundaries.

In other words, one monitoring camera can correspond to one monitoring scene. Specifically, in the embodiments of the present application, one monitoring scene can correspond to a plurality of mesh regions in the virtual scenes. Feature points are selected at the boundaries of the selected first and second regions, the boundary of a video picture to be superimposed onto the virtual scene is determined based on these feature points, and thus a part of the content within one monitoring video can be shield while reducing the distortion of the boundary, and accurately control access rights.

An embodiment of the present application provides a 3D monitoring system, including a housing, a processor, a memory, a circuit board and a power supply circuit, wherein the circuit board is arranged inside a space enclosed by the housing, the processor and the memory are provided on the circuit board; the power supply circuit is configured to supply power for various circuits or elements of the 3D monitoring system; the memory is configured to store executable program code, and the processor executes a program corresponding to the executable program code by reading the executable program code stored in the memory so as to perform the following steps:

displaying a virtual scene and a monitoring video of a monitored site;

obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring video is formed;

generating a first video mesh according to the first mapping, wherein a texture of the first video mesh is at least a part of the monitoring video; and

superimposing and displaying the first video mesh on the virtual scene.

By applying embodiments of the present application, two corresponding point sets are obtained through an input device respectively in the virtual scene and in the monitoring video, so as to obtain a mapping between the virtual scene and the monitoring video; and a video mesh, to be superimposed and displayed on the virtual scene, is generated based on this mapping. Thus, rapid deployment of a 3D monitoring system is achieved without calibration in intrinsic and extrinsic parameters of cameras, and the requirement on accuracy in matching between a 3D monitoring scene and an actual monitored site is decreased, greatly reducing the difficulty in system deployment while ensuring the effect of superimposing the monitoring video onto the virtual scene.

An embodiment of the present application provides an application program for performing the rapid deployment method for a 3D monitoring system, wherein the method can include:

displaying a virtual scene and a monitoring video of a monitored site;

obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring video is formed;

generating a first video mesh according to the first mapping, wherein a texture of the first video mesh is at least a part of the monitoring video; and

superimposing and displaying the first video mesh on the virtual scene.

By applying embodiments of the present application, two corresponding point sets are obtained through an input device respectively in a virtual scene and a monitoring video, so as to obtain a mapping between the virtual scene and the monitoring video; and a video mesh, to be superimposed and displayed on the virtual scene, is generated based on this mapping. Thus, a 3D monitoring system can be rapidly deployed without calibrations in intrinsic and extrinsic parameters of a camera, and requirements on accuracy in matching between a 3D monitoring scene and an actual monitored site are decreased to greatly reduce the difficulty in system deployment while ensuring the effect of superimposing the monitoring video onto the virtual scene.

An embodiment of the present application provides a storage medium, which is used for storing an application program configured to perform the rapid deployment method for a 3D monitoring system, wherein the method can include:

displaying a virtual scene and a monitoring video of a monitored site;

obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring videos if formed;

generating a first video mesh according to the first mapping, wherein a texture of the first video mesh is at least a part of the monitoring video; and superimposing and displaying the first video mesh on the virtual scene.

By applying embodiments of the present application, two corresponding point sets are obtained through an input device respectively in a virtual scene and a monitoring video, so as to obtain a mapping between the virtual scene and the monitoring video; and a video mesh, to be superimposed and displayed on the virtual scene, is generated based on this mapping. Thus, rapid deployment of a 3D monitoring system is achieved without calibration of intrinsic and extrinsic parameters of a camera, and the requirement on accuracy in matching between a 3D monitoring scene and an actual monitored site is decreased to greatly reduce the difficulty in system deployment while ensuring the effect of superimposing a monitoring video onto a virtual scene.

The embodiments of the system, the application program and the storage medium are briefly described, and reference can be made to the description of the embodiments of the method for its related contents since the embodiments of the system, application program and storage medium are substantially similar to those of the method.

It should be noted that, all the units mentioned in the embodiments of a device in the present application are logical units. Physically, a logical unit may be a physical unit, a part of a physical unit, or a combination of a plurality of physical units. It is not important that how the logical units are physically implemented, while the combination of functions accomplished by these logical units is the key to solve the technical problems put forward in the present application. In addition, in order to highlight the inventive part of the present application, units that are not closely related to the technical problems put forward herein are not described in the above system embodiments of the present application, which does not indicate that there are no other units in the above system embodiments.

It should be noted that the relationship terms in the claims and the description of the present application such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusion, such that processes, methods, articles or devices comprising a series of elements comprise not only those elements listed, but also other elements not specifically listed or elements intrinsic to these processes, methods, articles, or devices. Without further limitations, elements limited by such phrase “comprise(s) a/an . . . ” do not exclude that there are additional identical elements in the processes, methods, articles, or devices, which comprise the listed elements.

The present application has been illustrated and described with reference to certain preferred embodiments, a person having ordinary skills in the art would understand that various modifications may be made in form and detail without departing from the spirit and scope of the present application.

1. A rapid deployment method for a 3D monitoring system, comprising:
displaying a virtual scene and a monitoring video of a monitored site;
obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring video is formed;
generating a first video mesh according to the first mapping, wherein a texture of the first video mesh is at least a part of the monitoring video; and
superimposing and displaying the first video mesh on the virtual scene.

2. The rapid deployment method for a 3D monitoring system of claim 1, wherein the first point set is used to select a first region in the virtual scene, and the second point set is used to select a second region in the monitoring video;
the first point set contains at least four feature points located at the boundary of the selected first region, and the second point set contains at least four feature points located at the boundary of the selected second region.

3. The rapid deployment method for a 3D monitoring system of claim 1, wherein
the first point set is used to select a first region in the virtual scene, and the second point set is used to select a second region in the monitoring video;
the first point set contains at least one feature point located in the interior of the selected first region, and the second point set contains at least one feature point located in the interior of the selected second region.

4. The rapid deployment method for a 3D monitoring system of claim 1, wherein generating a first video mesh according to the first mapping comprises:
triangulating the first and second point sets respectively to generate triangle meshes; and
superimposing a monitoring video corresponding to a triangle mesh of the second point set, as a texture, onto a corresponding triangle mesh of the first point set according to the first mapping to generate the first video mesh.

5. The rapid deployment method for a 3D monitoring system of claim 4, wherein after the step of triangulating the first and second point sets respectively to generate triangle meshes, and before the step of superimposing a monitoring video corresponding to a triangle mesh of the second point set, as a texture, onto a corresponding triangle mesh of the first point set according to the first mapping to generate the first video mesh, the method further comprises:
determining whether the difference between the angle between any two edges of the triangle mesh of the first point set and the angle between corresponding two edges of the corresponding triangle mesh of the second point set is less than a preset threshold; and
if the difference is less than the preset threshold, superimposing a monitoring video corresponding to the triangle mesh of the second point set, as a texture, onto the corresponding triangle mesh of the first point set according to the first mapping to generate the first video mesh.

6. The rapid deployment method for a 3D monitoring system of claim 1, wherein after the step of displaying a virtual scene and a monitoring video of a monitored site, the method further comprises:
obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed;
generating a second video mesh according to the second mapping, wherein a texture of the second video mesh is at least a part of the same monitoring video; and
superimposing and displaying the second video mesh on the virtual scene.

7-12. (canceled)

13. A 3D monitoring system, comprising a housing, a processor, a memory, a circuit board and a power supply circuit, wherein the circuit board is arranged inside a space enclosed by the housing, the processor and the memory are provided on the circuit board; the power supply circuit is configured to supply power for various circuits or elements of the 3D monitoring system; the memory is configured to store executable program code, and the processor executes a program corresponding to the executable program code by reading the executable program code stored in the memory to perform the rapid deployment method for a 3D monitoring system of claim 1.

14. (canceled)

15. A storage medium for storing an application program that, when executed, performs the rapid deployment method of claim 1.

16. A 3D monitoring system, comprising:
a processor; and
a memory, coupled to the processor and having stored thereon program instructions that, upon execution by the processor, cause the system to perform a method comprising:
displaying a virtual scene and a monitoring video of a monitored site;
obtaining, through an input device, N points selected in the virtual scene as a first point set, and obtaining, through an input device, N points selected in the monitoring video as a second point set, wherein N is greater than 2, and there is a one-to-one correspondence between points in the first point set and points in the second point set respectively, so that a first mapping between the virtual scene and the monitoring video is formed;
generating a first video mesh according to the first mapping, wherein a texture of the first video mesh is at least a part of the monitoring video; and
superimposing and displaying the first video mesh on the virtual scene.

17. The 3D monitoring system of claim 16, wherein the first point set is used to select a first region in the virtual scene, and the second point set is used to select a second region in the monitoring video;
the first point set contains at least four feature points located at the boundary of the selected first region, and the second point set contains at least four feature points located at the boundary of the selected second region.

18. The 3D monitoring system of claim 16, wherein
the first point set is used to select a first region in the virtual scene, and the second point set is used to select a second region in the monitoring video;
the first point set contains at least one feature point located in the interior of the selected first region, and the second point set contains at least one feature point located in the interior of the selected second region.

19. The 3D monitoring system of claim 16, wherein generating a first video mesh according to the first mapping comprises:
triangulating the first and second point sets respectively to generate triangle meshes; and
superimposing a monitoring video corresponding to a triangle mesh of the second point set, as a texture, onto a corresponding triangle mesh of the first point set according to the first mapping to generate the first video mesh.

20. The 3D monitoring system of claim 19, wherein after the step of triangulating the first and second point sets respectively to generate triangle meshes, and before the step of superimposing a monitoring video corresponding to a triangle mesh of the second point set, as a texture, onto a corresponding triangle mesh of the first point set according to the first mapping to generate the first video mesh, the method further comprises:
determining whether the difference between the angle between any two edges of the triangle mesh of the first point set and the angle between corresponding two edges of the corresponding triangle mesh of the second point set is less than a preset threshold; and
if the difference is less than the preset threshold, superimposing a monitoring video corresponding to the triangle mesh of the second point set, as a texture, onto the corresponding triangle mesh of the first point set according to the first mapping to generate the first video mesh.

21. The 3D monitoring system of claim 16, wherein after the step of displaying a virtual scene and a monitoring video of a monitored site, the method further comprises:
obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed;
generating a second video mesh according to the second mapping, wherein a texture of the second video mesh is at least a part of the same monitoring video; and
superimposing and displaying the second video mesh on the virtual scene.

22. The rapid deployment method for a 3D monitoring system of claim 2, wherein after the step of displaying a virtual scene and a monitoring video of a monitored site, the method further comprises:
obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed;
generating a second video mesh according to the second mapping, wherein a texture of the second video mesh is at least a part of the same monitoring video; and
superimposing and displaying the second video mesh on the virtual scene.

23. The rapid deployment method for a 3D monitoring system of claim 3, wherein after the step of displaying a virtual scene and a monitoring video of a monitored site, the method further comprises:
obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed;
generating a second video mesh according to the second mapping, wherein a texture of the second video mesh is at least a part of the same monitoring video; and
superimposing and displaying the second video mesh on the virtual scene.

24. The rapid deployment method for a 3D monitoring system of claim 4, wherein after the step of displaying a virtual scene and a monitoring video of a monitored site, the method further comprises:
obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed;
generating a second video mesh according to the second mapping, wherein a texture of the second video mesh is at least a part of the same monitoring video; and
superimposing and displaying the second video mesh on the virtual scene.

25. The rapid deployment method for a 3D monitoring system of claim 5, wherein after the step of displaying a virtual scene and a monitoring video of a monitored site, the method further comprises:
obtaining, through an input device, N points selected in the virtual scene as a third point set, and obtaining, through an input device, N points selected in the same monitoring video as a fourth point set, wherein N is greater than 2, and there is a one-to-one correspondence between points in the third point set and points in the fourth point set respectively, so that a second mapping between the virtual scene and the monitoring video is formed;
generating a second video mesh according to the second mapping, wherein a texture of the second video mesh is at least a part of the same monitoring video; and
superimposing and displaying the second video mesh on the virtual scene.
